(19) United States
(12) Patent Application Publication
(10) Pub. No.: US 2009/0237596 A1
(43) Pub. Date: Sep. 24, 2009

(54) BACKLIGHT UNIT AND LIQUID CRYSTAL DISPLAY HAVING THE SAME

(75) Inventors: Jae-Chun PARK, Seoul (KR); Young-Bee CHU, Yonsin-si (KR); Ik-Soo LEE, Seoul (KR); Tae-Eun KIM, Suwon-si (KR); Seung-Gyun WOO, Seoul (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/407,480

(22) Filed: Mar. 19, 2009

(30) Foreign Application Priority Data
Mar. 19, 2008 (KR) 10-2008-0025534

(51) Int. Cl. G02F 1/1335; G09F 13/04

(52) U.S. Cl. 349/69; 362/97.3

(57) ABSTRACT

A backlight unit includes; a light emitting diode including a light output part, a light guide plate having a light input part positioned substantially opposite to the light output part of the light emitting diode, a mold frame configured to receive and fix the light emitting diode and the light guide plate therein, and a projection part disposed on the mold frame in a position corresponding to the light emitting diode and the light input part of the light guide plate, wherein a distance between the projection part and the light input part of the light guide plate is shorter than a distance between one side of the light output part of the light emitting diode and a rear surface of the other side of the light emitting diode

This application claims priority to Korean Patent application No. 10-2008-0025534, filed on Mar. 19, 2008, and all the benefits accruing therefrom under 35 U.S.C. §119, the contents of which in its entirety are herein incorporated by reference.

### BACKGROUND OF THE INVENTION

1. Field of the Invention

The present invention relates to a backlight unit and a liquid crystal display (“LCD”) having the same, and more particularly to a backlight unit and an LCD having the same, provided with a mold frame having a projection formed thereon.

2. Description of the Prior Art

Recently, flat panel displays, such as a liquid crystal displays (“LCDs”), plasma display panels (“PDPs”), or the like, have been rapidly developed in place of a cathode ray tube (“CRT”).

LCDs, which are a kind of flat panel display, have been used in computers, notebook computers, personal digital (data) assistants (“PDAs”), portable phones, televisions (“TVs”), audio/video appliances, and the like, due to their characteristics, such as light weight, thin type, low-power consumption, full color, high resolution, and other beneficial properties, and its application range has been expanded to commercial display fields. However, unlike the PDP, the LCD is not a self-illuminating device, and light sources are required. Various types of light sources are provided in the LCD in accordance with a display method of the LDC. For example, a backlight unit having light sources may be arranged on a rear surface of a liquid crystal display panel to form an LCD.

A backlight unit of a conventional LCD for use in a medium or small-sized portable device, such as a portable phone, a personal portable information terminal, and the like, is provided with a flat tetragonal light guide plate and a plurality of light emitting diodes (“LEDs”) positioned on the rear surface of the light guide plate. In such a conventional LCD, the plurality of LEDs are mounted at predetermined intervals on a substrate having a specified size, and an LED unit, in which the LEDs and the substrate are combined, is positioned on the side surface, e.g., a light input part, of the light guide plate. Also, in order to keep the luminance of the backlight unit uniform, it is important to make the light emitted from the LEDs uniformly incident to the light guide plate without light loss or leakage.

However, according to the conventional backlight unit having the above-described structure, when the LEDs are mounted on the substrate, the respective LED may have an error in mounting position. Although it is difficult to recognize such an error with human eyes, a gap is produced between the light output part of the LED and the light input part of the light guide plate due to the error in mounting position of the LED when the LED unit is positioned on a light-incident surface of the light guide plate. In addition to the error in mounting position, an assembly error may occur when the backlight unit is assembled. For example, in the case of the backlight unit using four LEDs, the light output part of only one LED may be in close contact with the light input part of the light guide plate while the light output parts of the three remaining LEDs may be separated from the light input parts of the light guide plate. In a display having such an assembly error, the backlight unit cannot achieve 100% light efficiency because all of the light from the LEDs is not input into the backlight unit.

Ad described above, according to the conventional backlight unit, a part of the light emitted from the LED cannot be incident to the light guide plate due to the gap between the light output part of the light emitting diode and the light input part of the light guide plate, and thus the light emitting efficiency of the backlight unit is deteriorated.

### BRIEF SUMMARY OF THE INVENTION

Accordingly, the present invention alleviates the above-mentioned problems occurring in the prior art, and an aspect of the present invention is to provide a backlight unit and a liquid crystal display (“LCD”) having the same, which can maximize the light emitting efficiency by positioning a light output part of a light emitting diode and a light input part of a light guide plate in close contact with each other.

Additional advantages, aspects, and features of the invention will be set forth in part in the description which follows and in part will become apparent to those having ordinary skill in the art upon examination of the following or may be learned from practice of the invention.

An exemplary embodiment of a backlight unit according to the present invention includes: a light emitting diode including a light output part, a light guide plate having a light input part positioned substantially opposite to the light output part of the light emitting diode, a mold frame configured to receive and fix the light emitting diode and the light guide plate thereto, and a projection part disposed on the mold frame in a position corresponding to the light emitting diode and the light input part of the light guide plate, wherein a distance between the projection part and the light input part of the light guide plate is shorter than a distance between one side of the light output part of the light emitting diode and a rear surface of the other side of the light emitting diode.

In one exemplary embodiment, the mold frame may include a sidewall configured to fix the light guide plate thereto, and the projection part may be disposed on the sidewall. However, features of the mold frame and the projection part are not limited thereto. In one exemplary embodiment, the mold frame may include a flat part extending from the sidewall of the mold frame to an inner side thereof, and wherein the projection part may be disposed on the flat part. In one exemplary embodiment, the mold frame may include a recess part disposed on the flat part of the mold frame, the recess part being configured to receive the light emitting diode therein, and wherein the projection part may be disposed on the recess part. In one exemplary embodiment, the light guide plate may include a flat base plate, a plurality of guide parts projected from a side of the base plate, and a light input part disposed between adjacent guide parts of the plurality of guide parts. In one exemplary embodiment, the light guide plate is supported by the flat part of the mold frame. In another exemplary embodiment the projection part has a rounded edge in a direction corresponding to a direction from which the light emitting diode is mounted.

In one exemplary embodiment, the projection part contacts the rear surface of the light emitting diode. In one exemplary embodiment, the light emitting diode may include a concave part and convex parts disposed on the rear surface thereof, wherein the convex parts may be disposed on substantially opposite sides of the rear surface of the light emitting diode, and the concave part may be disposed between the convex parts. In one exemplary embodiment, a width of the concave part on the rear surface of the light emitting diode corresponds to a width of the projection part. However, the widths of the concave part and the projection part are not limited thereto. In one exemplary embodiment, the projection part may be formed to be in contact with the concave part and the convex part of the light emitting diode, and in this exemplary embodiment, a width of the rear surface of the light emitting diode and the width of the projection may correspond to each other.

In addition, in one exemplary embodiment, the projection part may include an elastic member, and the elastic member may be at least one of a plate spring, rubber and sponge. In one exemplary embodiment, the plate spring extends from the mold frame to a rear surface of the light emitting diode, and is bent in one of an upward and downward direction.

In addition, in one exemplary embodiment, the projection part and the mold frame may be a single, indivisible unitary body. In another exemplary embodiment, the projection part and the mold frame may be separately prepared and then attached to the mold frame.

In another exemplary embodiment of the present invention, there is provided a liquid crystal display, which includes; a liquid crystal display panel, and a backlight unit configured to supply light to the liquid crystal display panel, and including; a light emitting diode including a light output part, a light guide plate having a light input part positioned substantially opposite to the light output part of the light emitting diode, a mold frame configured to receive and fix the light emitting diode and the light guide plate therein, and a projection part disposed on the mold frame in a position corresponding to the light emitting diode and the light input part of the light guide plate, wherein a distance between the projection part and the light input part of the light guide plate is shorter than a distance between one side of the light output part of the light emitting diode and a rear surface of the other side of the light emitting diode.

In one exemplary embodiment, the projection part is in contact with a rear surface of the light emitting diode. In one exemplary embodiment, the light emitting diode may include a concave part and convex parts disposed on the rear surface thereof, wherein the convex parts may be disposed on opposing sides of the rear surface of the light emitting diode, and the concave part may be disposed between the convex parts. In one exemplary embodiment, a width of the concave part on the rear surface of the light emitting diode corresponds to a width of the projection part. The widths of the concave part and the projection part are not limited thereto, and, in one exemplary embodiment, a width of the rear surface of the light emitting diode and the width of the projection may correspond to each other.

It is to be understood that both the foregoing general description and the following detailed description are exemplary and explanatory and are intended to provide further explanation of the invention as claimed.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view schematically illustrating a first exemplary embodiment of a backlight unit according to the present invention;

FIG. 2 is a top plan view of the first exemplary embodiment of a backlight unit according to the present invention;

FIG. 3A is cross-sectional view illustrating a first exemplary embodiment of a projection part taken along line A-A of FIG. 2;

FIG. 3B is cross-sectional view illustrating a second exemplary embodiment of a projection part taken along line A-A of FIG. 2;

FIG. 4 is an enlarged top plan view of a first exemplary embodiment of the “B” region of FIG. 2;

FIG. 5 is an enlarged top plan view of a second exemplary embodiment of the “B” region of FIG. 2;

FIG. 6 is an exploded perspective view schematically illustrating a second exemplary embodiment of a backlight unit according to the present invention;

FIG. 7 is a top plan view of the second exemplary embodiment of a backlight unit according to the present invention;

FIG. 8A is cross-sectional view illustrating a first exemplary embodiment of a projection part taken along line E-E of FIG. 7;

FIG. 8B is a cross-sectional view illustrating a second exemplary embodiment of a projection part taken along line E-E of FIG. 7;

FIG. 9 is an enlarged top plan view of a first exemplary embodiment of the “F” region of FIG. 7;

FIG. 10 is an enlarged top plan view of a second exemplary embodiment of the “F” region of FIG. 7; and

FIG. 11 is an exploded perspective view schematically illustrating an exemplary embodiment of a liquid crystal display according to the present invention.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

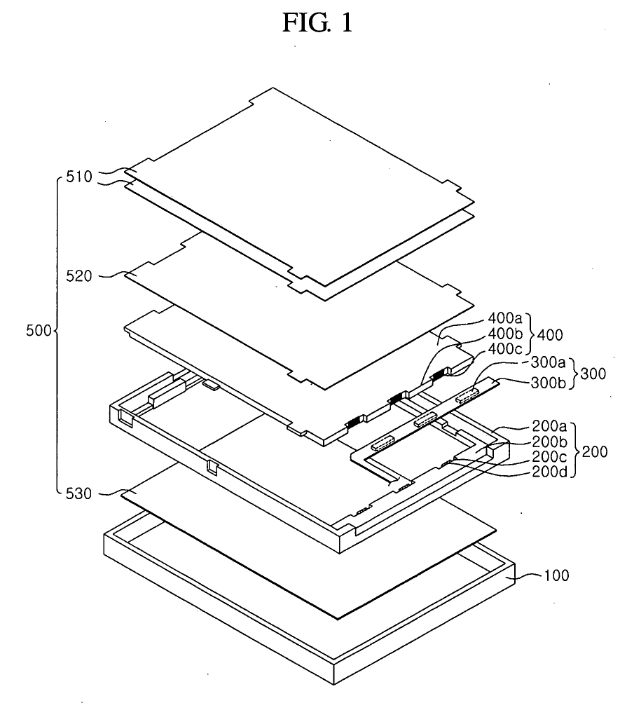

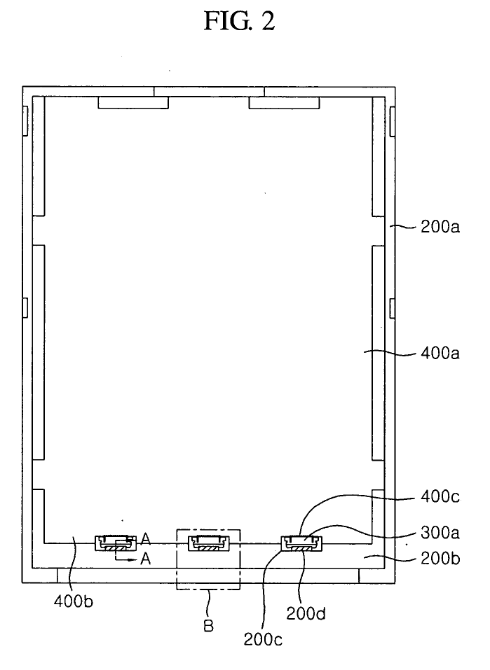

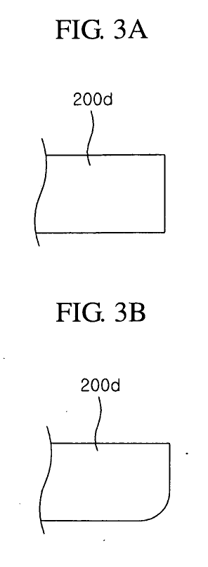

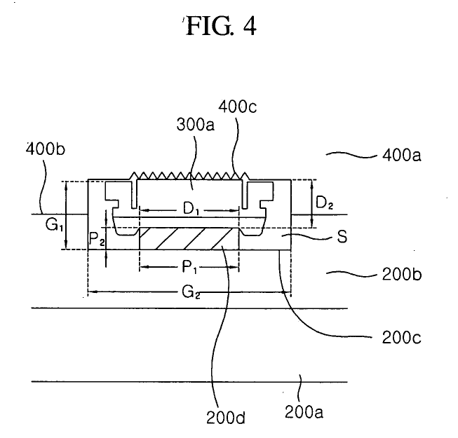

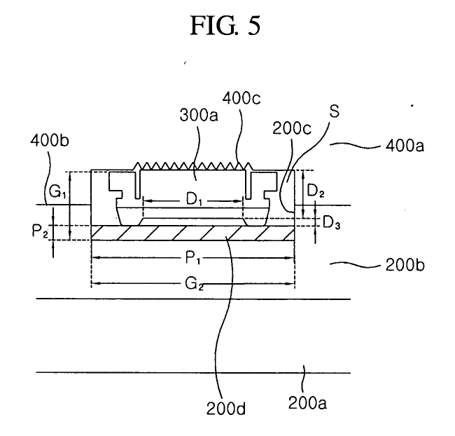

FIG. 1 is an exploded perspective view schematically illustrating a first exemplary embodiment of a backlight unit according to the present invention. FIG. 2 is a top plan view of the first exemplary embodiment of a backlight unit according to the present invention, FIGS. 3A and 3B are cross-sectional view of the exemplary embodiment of a backlight unit, taken along line A-A of FIG. 2, and FIGS. 4 and 5 are enlarged top plan views of a first and second exemplary embodiment of the “B” region of FIG. 2, respectively.

The first exemplary embodiment of a backlight unit according to the present invention, as illustrated in FIGS. 1 and 2, includes a light guide plate 400, a light emitting diode (“LED”) unit 300 arranged on at least one side surface of the light guide plate 400, and a mold frame 200 receiving and fixing the light guide plate 400 and the light emitting diode unit 300 thereto. The first exemplary embodiment of a backlight unit further includes optical sheets 500 positioned on upper and lower parts of the light guide plate 400, and a lower receiving member 100 receiving the mold frame 200 therein, to which the light guide plate 400, the light emitting diode unit 300, and the optical sheets 500 are fixed, to protect the mold frame 200.

The light guide plate 400 converts light emitted from the LED unit 300 from a point light source into a surface light source, and includes a base plate 400a converting the light emitted from a LED 300a into the surface light source by scattering the light, a plurality of guide parts 400b facilitating the mounting of the LED 300a, and a light scattering pattern 400c formed on a light input part between the guide parts 400b. In this case, the guide parts 400b project a specified distance from one side of the base plate 400a, and in one exemplary embodiment of the present invention, a plurality of tetragonal guide parts 400b are projected from the side of the base plate 400a.

In one exemplary embodiment, the light guide plate 400 is made of a transparent material having a specified refraction ratio, such as polyolefin, polycarbonate, or other materials having similar characteristics. In one exemplary embodiment, the light guide plate 400 is made from a typical acrylic resin, e.g., poly methyl methacrylate (“PMMA”). The LED unit 300 is positioned on a side surface of the light guide plate 400. The side surface of the light guide plate 400 may also be referred to as a light input part. The light scattering pattern 400c may then be disposed on the light input part. In the current exemplary embodiment, the light emitted from the LED unit 300 is incident through the light scattering pattern 400c, and then supplied upward through the base plate 400a. Alternative exemplary embodiments include configurations wherein the guide part 400b and the light scattering pattern 400c may be omitted.

The LED unit 300 is a main light source of the backlight unit, and includes LEDs 300a, and a board 300b for packaging the LEDs 300a. In the current exemplary embodiment, a side-emitting LED having a side surface, on which the light output part is positioned when the LED 300a is mounted on the board 300b, is used as the LED 300a. In such an exemplary embodiment, a flexible printed circuit board (“PCB”) having a high degree of flexibility may be used as the board 300b. The flexible PCB includes a circuit formed thereon, and an external power is supplied to the LED 300a through the circuit. Also, in one exemplary embodiment the LED unit 300 may be attached to the side surface of the light guide plate 400 by using an adhesive member (not illustrated) such as a double-sided adhesive tape. Alternative exemplary embodiments include configurations wherein the LEDs 300a may be affixed to the light guide plate 400 and powered using other means as would be apparent to one of ordinary skill in the art.

The optical sheets 500 are arranged on the upper part and the lower part of the light guide plate 400 to make the luminance distribution of the emitted light uniform, and, in the present exemplary embodiment, includes a diffusion sheet 520, a prism sheet 510, and a reflection sheet 530. The diffusion sheet 520 directs the light incident from the LED unit 300 toward a rear surface of the liquid crystal panel, diffuses the light so that it has a uniform distribution in a wide range of viewing angles, and then irradiates the light onto the liquid crystal display (“LCD”) panel. The prism sheet 510 refracts the inclined light at right angles among the lights incident to the prism sheet 510. The reflection sheet 530 reflects the light output to the lower surface of the light guide plate 400, so that the reflected light is re-incident into the light guide plate 400. In one exemplary embodiment, the reflection sheet 530 may be positioned on the lower surface of the light guide plate 400.

The mold frame 200 receives and fixes the light guide plate 400, the LED unit 300, and the optical sheets 500 thereto, and, in the present exemplary embodiment, is in the form of a tetragon. The mold frame 200 includes a sidewall 200a, a flat part 200b bent in a direction substantially perpendicular to the sidewall 200a, a recess part 200c concavely formed on the flat part 200b, and a projection part 200d formed on the recess part 200c.

In one exemplary embodiment, the sidewall 200a is prepared in a shape corresponding to the light guide plate 400 and the optical sheets 500 so that the sidewall receives and protects the light guide plate 400 and the optical sheet 500. In the current embodiment of the present invention, the light guide plate 400 and the optical sheets 500 are in the form of a tetragon, and thus the sidewall 200a of the mold frame 200 includes first to fourth sidewalls in the form of a tetragon. However, the feature of the sidewall is not limited thereto, and the shape of the sidewall 200a of the mold frame 200 may differ in accordance with the shape of the light guide plate 400 and the optical sheets 500 as would be apparent to one of ordinary skill in the art.

The flat part 200b supports the light guide plate 400, and includes a flat part 200b extending from the sidewall 200a to the inside of the mold frame 200. In the current exemplary embodiment, the flat part 200b includes first to fourth flat parts extending from the first to fourth sidewalls, respectively. The respective flat parts are bent at specified angles from the first to fourth sidewalls, respectively, and extend to support the light guide plate 400 and the optical sheets 500. In order to support the light guide plate 400 and the optical sheets 500, the first to fourth flat parts are bent from the first to fourth sidewalls in directions substantially perpendicular to the first to fourth sidewalls, respectively. Also, on one of the flat parts extending from the first to fourth sidewalls, i.e., on the flat part on which the LED 300a is mounted, a recess part 200c is formed in a direction substantially parallel to the sidewall. In this case, the flat part on which the recess part 200c is formed may not support the light guide plate 400 and the optical sheets 500 in order to secure a space in which the LED may be positioned.

The recess part 200c provides a space in which the LED 300a may be positioned, and is formed on one of the first to fourth flat parts, on which the LED 300a is to be mounted, e.g., on the first flat part 200b. In one exemplary embodiment, the recess part 200c is formed to correspond to the shape of the LED 300a, and the number of the recess parts 200c corresponds to the number of LEDs 300a. That is, in one exemplary embodiment of the present invention, three LEDs 300a are used, and thus the recess part 200c includes first to third recess parts 200c. Exemplary embodiments also include configurations wherein a portion of the flat part 200b may be concavely formed to correspond to the shape of the LED 300a, for example, in the form of a tetragon. Also, since the LED 300a is positioned apart from the light input part of the light guide plate 400 by a specified distance, the recess part 200c is also spaced a specified distance apart from the end of the flat part 200b to correspond to the position of the LED 300a. Alternative exemplary embodiments include configurations wherein the recess part 200c may be omitted.

The projection part 200d positions the light output part of the LED 300a in close contact with the light input part of the light guide plate 400, and is formed on the recess part 200c. In one exemplary embodiment, the projection part 200d may be made of substantially the same material as the mold frame 200. Alternative exemplary embodiments include configurations wherein the projection part 200d may be made from a material different from the mold frame 200. Also, exemplary embodiments include configurations wherein the projection part 200d may be manufactured as a single, unitary and indivisible body with the mold frame 200 and exemplary embodiments wherein the projection part 200d may be separately manufactured and then attached to the mold frame 200. If the projection part 200d is made of a material different from the mold frame 200, the projection part 200d may be separately manufactured and then attached to the mold frame 200, while if the projection part 200d is made of the same material as the mold frame 200, the projection part 200d may be manufactured in a body with the mold frame 200 to save manufacturing costs.

In one exemplary embodiment, the number of the projection parts 200d is substantially the same as the number of the LEDs 300a. In the current exemplary embodiment of the present invention, three LEDs, e.g., the first to third LEDs, are provided, and thus first to third projection parts may be formed on the first to third recess parts in order to position the first to third LEDs in close contact with the light guide plate 400. Alternative exemplary embodiments include configurations wherein the number of projection parts 200d may be increased or decreased in accordance with the number of LEDs 200a.

In one exemplary embodiment the projection part 200d is formed on the recess part 200c that is positioned on the opposite surface of the light out put part of the LED 300a, and pushes the LED 300a with pressure outward against the light guide plate 400, so that the LED 300a becomes in close contact with the light guide plate 400. That is, in one exemplary embodiment, the mold frame 200 projects from the recess part 200c toward the LED 300a. In such an exemplary embodiment, if the recess part is omitted, the projection part 200d may be formed on the flat part 200b corresponding to the position where the LED 300a is mounted. In the exemplary embodiment where the recess part 200c is omitted, the flat part 200b, on which the recess part 200c is to be formed, can also be omitted, and in such an exemplary embodiment the projection part 200d may be formed on the sidewall 200a corresponding to the position where the LED 300a is mounted.

The projection part 200d, as illustrated in FIG. 3A, may be, but is not limited to, in the form of a tetragon in cross section along a direction where the projection part 200d is projected. As illustrated in FIG. 3B, an edge of the projection part 200d in a direction where the LED 300a is mounted may be rounded for easy mounting of the LED 300a. In an alternative exemplary embodiment, the projection part 200d may have entirely rounded edges (not shown). That is, alternative exemplary embodiments of the projection part 200d may have substantially any shape (e.g., they may be in the form of a polygon, a semicircle, or a half-ellipse in cross section in the direction where the projection part 200d is projected) that can position the light output part of the LED 300a in close contact with the light input part of the light guide plate 400 via contact pressure. In the illustrated exemplary embodiments, one recess part 200c is provided with one projection part 200d formed thereon. However, alternative exemplary embodiments may include more than one projection part 200d formed in an individual recess part 200c.

According to an exemplary embodiment of the backlight unit according to the present invention, as illustrated in FIG. 4, the recess part 200c is formed in the flat part 200b that is bent and extends from the sidewall 200a of the mold frame 200c, and the projection part 200d projecting in a direction toward the inside of the mold frame 200 is formed on the recess part 200c. The light guide plate 400 is mounted on the mold frame 200, and the LED 300a is positioned between the projection part 200d and the light input part of the light guide plate 400. That is, the light output part of the LED 300a is arranged in close contact with the light input part on which the light scattering pattern 400c is formed. In the exemplary embodiment shown in FIG. 4, the LED 300a includes a concave part and convex parts formed on the rear surface thereof, e.g., on the surface opposite to the projection part 200d. That is, one side portion and the other side portion of the rear surface are projected to form the convex parts, and the concave part is formed between the convex parts.

The width P1 of the projection part 200d corresponds to the width D1 of the concave part of the LED 300a, and in one exemplary embodiment, the width P1 of the projection part 200d is set to be equal to or smaller than the width D1 of the concave part of the LED 300a. If the width P1 of the projection part 200d is equal to the with D1 of the concave part of the LED 300a, the movement of the LED 300a left and right is prevented by the projection part 200d, e.g., the ends of the concave part act as end-stops for the projection part 200d thereby fixing the LED 300a in a longitudinal direction in addition to a lateral direction, and thus the misalignment between the light scattering pattern 400c of the light guide plate 400 and the light output part of the LED is prevented. On the other hand, the thickness P2 of the projection part 200d is defined as a length projected from the sidewall 200a, and the width P1 of the projection part 200d is defined as a length of a surface that is substantially parallel to the flat part 200b on which the projection part 200d is formed.

In the assembled backlight unit, the side surfaces of the projected guide parts 400b of the light guide plate 400 and the flat parts 200b are in contact with each other, and a space S for mounting the LED is formed by the projected guide parts of the light guide plate 400 and the recess part 200c. In such an exemplary embodiment, the space S for mounting the LED, which is formed by the guide parts 400b and the recess part 200c, is formed to correspond to the shape and the size of the LED 300a. In the exemplary embodiment illustrated in FIG. 4, the space S for mounting the LED is in the form of a tetragon that is larger than the tetragonal LED 300a, and the area of the space S is represented by a first length G1 and a second length G2 that is longer than the first length G1. In such an exemplary embodiment, the first length G1 corresponds to the distance between the light input part, on which the light scattering pattern 400c of the light guide plate 400 is formed, and the recess part 200c, on which the projection part 200d is formed. In accordance with the above-described structure the sum of the thickness P2 of the projection part 200d and the thickness D2 between the light output part of the LED 300a and the projection part 200d, is substantially equal to the first length G1 of the space S for mounting the LED (e.g., G1=P2+D2) in order to improve light emitting efficiency. That is, the LED 300a is inserted between the light input part of the light guide plate 400 and the projection part 200d of the mold frame 200, so that most light emitted from the LED 300a is incident to the light input part of the light guide plate 400.

As shown in FIGS. 4 and 5 an exemplary embodiment of an LED 300 includes an uneven rear surface including the concavity. However, alternative exemplary embodiments of the LED 300a according to the present invention may not have the concave part and the convex parts formed on the rear surface of the LED 300a. That is, according to the present invention, an exemplary embodiment of the LED including an even rear surface may be used, and in such an exemplary embodiment, the projection part 200d presses the even rear surface of the LED against the light input part of the light guide plate 400 in order to ensure close contact therebetween.

Also, even if the LED having the concave part and the convex parts formed on the rear surface thereof is used according to the embodiment of the present invention, as shown in FIG. 5, the width P1 of the projection part 200d may be increased, so that the projection part 200d contacts the convex part of the rear surface of the LED. In an exemplary embodiment, the width P1 of the projection 200d may be the same as or larger than the width of the rear surface of the LED. In such an alternative exemplary embodiment, the various dimensions D2, P2 and G1 may be varied accordingly as discussed below.

In one exemplary embodiment, the first length G1 of the space S for mounting the LED is substantially equal to the sum of the thickness P2 of the projection part 200d, the thickness D2 between the light output part of the LED 300a and the rear surface of the concave part thereof, and a distance D3 between the concave part of the LED 300a and the convex part (i.e., G1=P2+D2+D3). That is, the present invention can be applied to any structure in which the projection part 200d is formed on the mold frame 200, and wherein the projection part 200d ensures close contact between the light output part of the LED and the light input part of the light guide plate 400.

As described above, in the first exemplary embodiment of the present invention, the projection parts 200d formed on the recess parts 200c can position the respective light output parts of the LEDs 300a in close contact with the light input parts of the light guide plate 400, respectively. Also, in the case where the light output parts of the LEDs 300a are in close contact with the light input parts of the light guide plate 400, a luminance difference between the LEDs 300a is prevented, and thus the luminance of the entire backlight unit becomes uniform. Also, since the light input part of the light guide plate 400 is in close contact with the light output part of the LED 300a, most light emitted from the LED 300a is incident to the light guide plate 400, and thus the luminance deterioration due to a gap between the LED 300a and the light guide plate 400 can be prevented.

Hereinafter, a second exemplary embodiment of a backlight unit according to the present invention will be described with reference to the accompanying drawings. In the following description of the present invention, duplicate explanation of the backlight unit which is substantially similar to the description of the first exemplary embodiment of a backlight unit of the present invention will be omitted or will only be briefly stated.

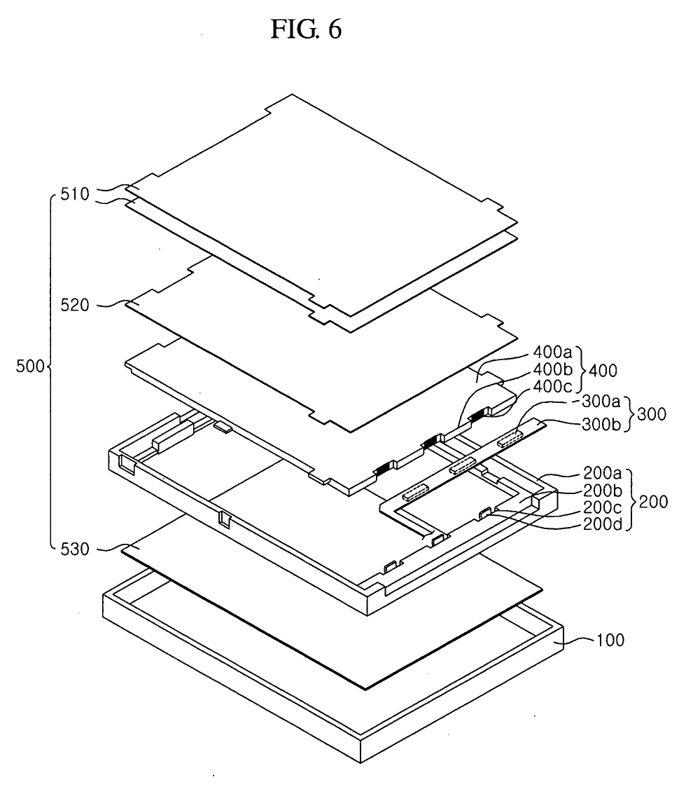

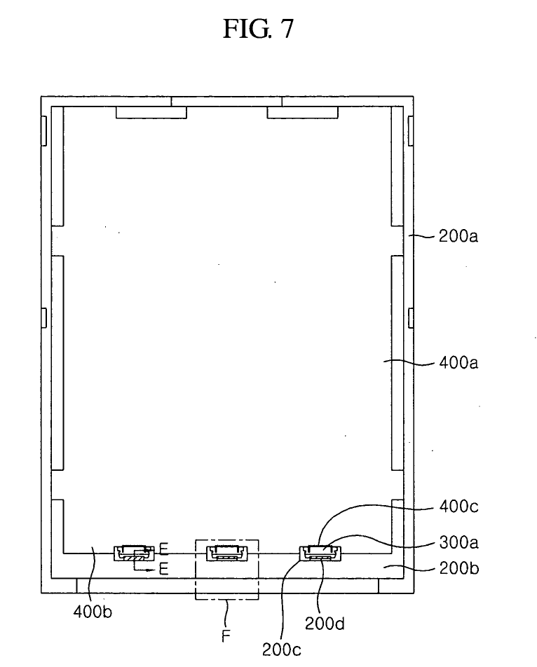

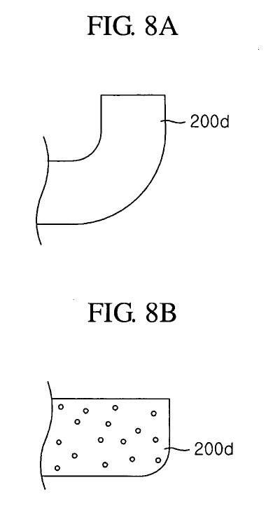

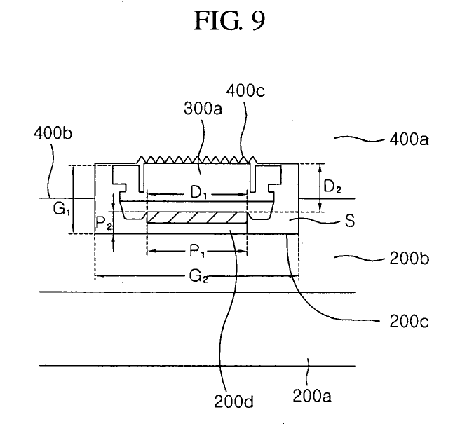

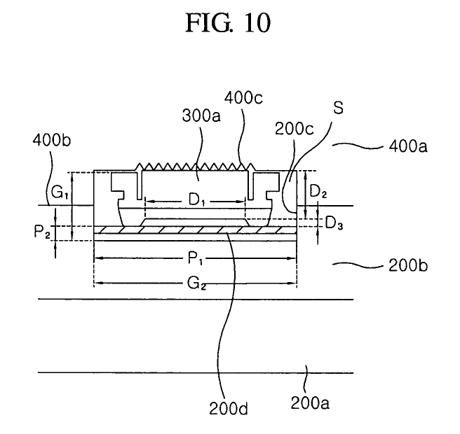

FIG. 6 is an exploded perspective view schematically illustrating a second exemplary embodiment of a backlight unit according to the present invention, and FIG. 7 is a top plan view of the second exemplary embodiment of a backlight unit according to the present invention. FIGS. 8A and 8B are cross-sectional views illustrating first and second exemplary embodiments of a projection part, respectively, taken along line E-E of FIG. 7, and FIGS. 9 and 10 are enlarged top plan views of first and second exemplary embodiments of the “F” region of FIG. 7, respectively.

As illustrated in FIGS. 6 and 7, the second exemplary embodiment of a backlight unit according to the present invention includes a light guide plate 400, an LED unit 300 arranged on a side surface of the light guide plate 400, and a mold frame 200 receiving and fixing the light guide plate 400 and the LED unit 300 thereto. The second exemplary embodiment of a backlight unit further includes optical sheets 500 positioned on upper and lower parts of the light guide plate 400, and a receiving member 100 receiving the mold frame 200, to which the light guide plate 400, the LED unit 300, and the optical sheets 500 are fixed, therein to protect the mold frame 200.

The light guide plate 400 converts light emitted from the LED 300a from a point light source into a surface light source. In substantially the same manner as the first exemplary embodiment of the present invention, the light guide plate 400 includes a base plate 400a converting the light emitted from an LED 300a into the surface light source by scattering the light, a plurality of guide parts 400b facilitating the mounting of the LED 300a, and a light scattering pattern 400c formed on a light input part between the guide parts 400b. As discussed above, alternative exemplary embodiments include configurations wherein the guide part 400b and the light scattering pattern 400c may be omitted.

The LED unit 300 is a main light source of the backlight unit 1000, and includes LEDs 300a, and a board 300b for packaging the LEDs 300a. In the same manner as the first exemplary embodiment of the present invention, a side-emitting LED having a side surface, on which the light output part is positioned when the LED 300a is mounted on the board 300b, is used as the LED 300a.

The mold frame 200 receives and fixes the light guide plate 400, the LED unit 300, and the optical sheets 500 thereto, and, in the present exemplary embodiment, is in the form of a tetragon. The mold frame 200 includes a sidewall 200a, a flat part 200b bent in a direction crossing the sidewall 200a, a recess part 200c formed on the flat part 200b, and a projection part 200d formed on the recess part 200c. Alternative exemplary embodiments include configurations wherein the mold frame 200 is formed in shapes other than a tetragon.

The projection part 200d according to the second exemplary embodiment of the present invention, unlike the projection part according to the first exemplary embodiment of the present invention, is in the form of a plate spring. That is, as illustrated in FIG. 8A, the projection part 200d is formed to be projected to the inner side of the sidewall 200a and then to be bent upward, and the light output part of the LED is in positioned in close contact with the light input part of the light guide plate 400 by the elasticity of the projection part 200d. In one exemplary embodiment the projection part 200d may be bent in a direction substantially opposite to the mounting direction of the LED 300a in order to facilitate the mounting of the LED 300a. In the exemplary embodiment wherein the projection part 200d is formed as the plate spring, the projection part 200d may be bent towards the recess part 200c by the mounting pressure of the LED 300a.

In one exemplary embodiment, the projection part 200d is made of a material having specified strength and elasticity to prevent the projection part 200d from being damaged even if pressure is applied to the projection part 200d when the LED 300a is mounted. After the LED 300a is mounted, the projection part 200d pushes the LED 300a with the restoring force thereof and positions the LED 300a in close contact with the light input part of the light guide plate 400.

In the embodiment shown in FIGS. 6 and 7, the mold frame 200 and the projection part 200d are formed of the same material in a single, unitary and indivisible body, and the projection part 200d is formed in the shape of a plate spring so that it can be formed by injection molding. However, in the exemplary embodiment wherein the projection part 200d is separately manufactured and attached to the mold frame 200, the shape of the projection part 200d may differ. In such an alternative exemplary embodiment, the projection part 200d may be in the form of a dome spring. If the projection part 200d and the mold frame 200 are made of different materials, the projection part 200d, as illustrated in FIG. 8B, may be made of a non-resinous elastic member, exemplary embodiments of which include rubber, sponge and other similar materials. In the case where the projection part 200d is formed of a non-resinous elastic member, the projection part 200d may have specified strength enough to position the light output part of the LED 300a in close contact with the light input part of the light guide plate 400 even though its shape may be changed when the LED 300a is mounted. In such an exemplary embodiment, the projection part 200d may be attached to the mold frame 200 by an adhesive member. Also, the projection part 200d may be attached to the rear surface of the LED 300a. In the embodiment of the present invention illustrated in FIGS. 7-10, one recess part 200c is provided with one projection part 200d formed thereon. However, alternative exemplary embodiments include configurations wherein more than one projection part 200d may also be formed on the recess part 200c.

In the second exemplary embodiment of a backlight unit according to the present invention, as illustrated in FIG. 9, the width P1 of the projection part 200d corresponds to the width D1 of the concave part of the LED 300a, and preferably, the width P1 of the projection part 200d is substantially equal to or smaller than the width D1 of the concave part of the LED 300a. In this case, the thickness P2 of the projection part 200d is defined as the length the projection part 200d projects from the recess part 200c, and the width P1 of the projection part 200d is defined as a length of a surface that is substantially parallel to the flat part 200b on which the projection part 200d is formed.

In the second exemplary embodiment of the present invention, a tetragonal space S for mounting the tetragonal LED is formed. The area of the space S is represented by a first length G1 and a second length G2 that is longer than the first length G1. In this case, the first length G1 corresponds to the distance between the light input part, on which the light scattering pattern 400c of the light guide plate 400 is formed, and the recess part 200c. In the first exemplary embodiment of the present invention as described above, the sum of the thickness P2 of the projection part 200d and the thickness D2 between the light output part of the LED 300a and a rear surface thereof, which is in contact with the projection part 200d, is set to be equal to the first length G1 of the space S for mounting the LED in order to position the light input part of the light guide plate 400 in close contact with the light output part of the LED 300a.

However, in the second exemplary embodiment of the present invention, the projection part 200d may have substantial elasticity, and thus it is not necessary that the sum of the thickness P2 of the projection part 200d and the thickness D2 between the light output part of the LED 300a and the rear surface, which is in contact with the projection part 200d, be substantially equal to the first length G1 of the space S for mounting the LED. That is, when the LED 300a is mounted, the thickness P2 of the projection part 200d may be reduced by the pressure applied during mounting of the LED, and thus the sum of the thickness P2 of the projection part 200d and the thickness D2 between the light output part of the LED 300a and the rear surface thereof, which is in contact with the projection part 200d, is set to be larger than the first length G1 of the space S for mounting the LED (e.g., G1<P2+D2). In such an exemplary embodiment, the space S may be suitably arranged for mounting the LED 300a therein. After the LED 300a is mounted, the first length G1 of the space S for mounting the LED becomes substantially equal to the sum of the thickness P2 of the projection part 200d and the thickness D2 between the light output part of the LED 300a and the rear surface that is in contact with the projection part 200d.

In the same manner as the first exemplary embodiment of the present invention, an LED having an even rear surface may be used. As illustrated in FIG. 10, the width P1 of the projection part 200d may be increased, and the projection part 200d may be in contact with the convex part of the rear surface of the LED. That is, the present invention can be applied to any structure in which the projection part 200d having elasticity is formed on the mold frame 200, and wherein the projection part 200d having the elasticity ensures close contact between the light output part of the LED 300a and the light input part of the light guide plate 400.

As described above, in the second exemplary embodiment of the present invention, the elastic projection parts 200d formed on the recess parts 200c can position the respective light output part of the LEDs 300a in close contact with the light input parts of the light guide plate 400, irrespective of the thickness error and assembly error of the LED 300a. Also, in the case of forming the projection part 200d having the elasticity, the LEDs 300a can be in close contact with the light input parts of the light guide plate, respectively, even if the LEDs have different thicknesses, and thus the luminance of the backlight unit becomes uniform on the whole.

Hereinafter, an exemplary embodiment of an LCD according to the present invention will be described with reference to the accompanying drawings. In the following description of the present invention, duplicate explanation of the backlight unit according to the first and second embodiments of the present invention will be omitted or will be briefly made.

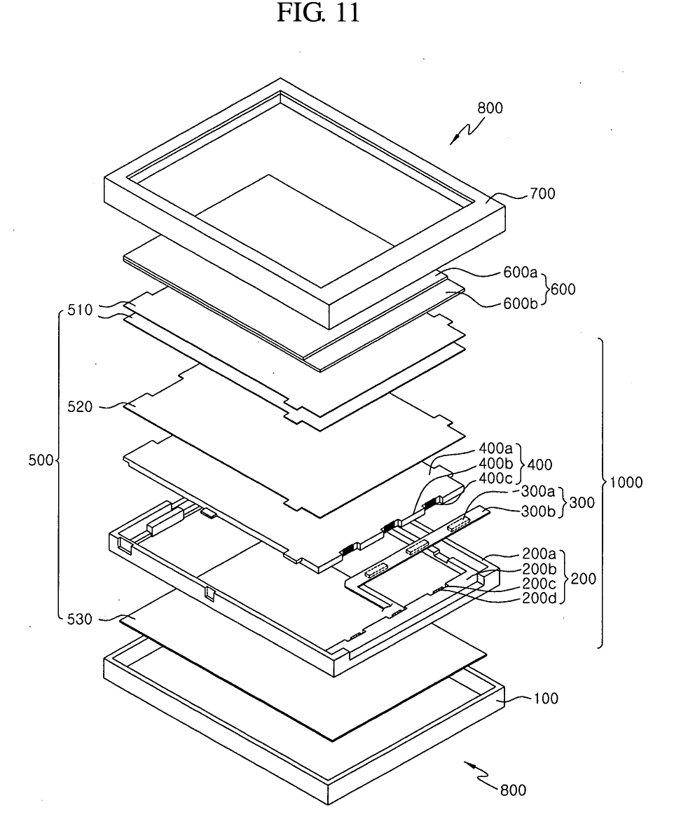

FIG. 11 is an exploded perspective view schematically illustrating an exemplary embodiment of an LCD according to the present invention.

The exemplary embodiment of an LCD according to the present invention, as illustrated in FIG. 11, includes an LCD panel 600, and a backlight unit 1000 provided with a mold frame 200 on which a projection part 200d is formed. The LCD may further include a receiving member 800 for receiving and protecting the LCD panel 600 and the backlight unit 200.

The LCD panel 600 is configured to display an image, and includes a thin film transistor substrate 600b, a color filter substrate 600a corresponding to the thin film transistor substrate 600b, and a liquid crystal layer (not illustrated) interposed between the thin film transistor substrate 600b and the color filter substrate 600a. The LCD panel 600 may further include a polarizing plate (not illustrated) formed to correspond to the upper part of the color filter substrate 600a and the lower part of the thin film transistor substrate 600b.

In one exemplary embodiment, the thin film transistor substrate 600b is a transparent glass substrate on which thin film transistors and pixel electrodes are formed in the form of a matrix. In such an exemplary embodiment, data lines may be connected to source terminals of the thin film transistors, and gate lines may be connected to gate terminals thereof Also, the pixel electrodes (not illustrated) composed of transparent electrode made of a transparent conductive material are connected to drain terminals thereof. When electric signals are applied to the data lines and the gate lines, the respective thin film transistors are turned on/off, and electric signals required to form images are applied to the drain electrodes thereof

In one exemplary embodiment, the color filter substrate 600a may be a substrate on which color filters of red (R), green (G), and blue (B) that produce specified colors as light passes through the color filter substrate are formed. In one exemplary embodiment a common electrode (not illustrated), made of a transparent conductor, exemplary embodiments of which include indium tin oxide (“ITO”) or indium zinc oxide (“IZO”), is formed on substantially the entire surface of the color filter substrate 600a. The LCD panel 600 receives the signals from an LCD panel driving part (not illustrated) and displays the image in accordance with the received signals.

The backlight unit 1000 includes a light guide plate 400, an LED unit 300 arranged on a side surface of the light guide plate 400 and provided with LEDs 300a and a substrate 300b on which the LEDs are mounted, and a mold frame 200 receiving and fixing thereto the light guide plate 400 and the LED unit 300. In one exemplary embodiment, the backlight unit 1000 further includes optical sheets 500 positioned on upper and lower parts of the light guide plate 400.

The light guide plate 400 converts light emitted from the LED 300a from a point light source into a surface light source, and includes a base plate 400a converting the light emitted from an LED 300a into the surface light source by scattering the light, a plurality of guide parts 400b facilitating the mounting of the LED 300a, and a light scattering pattern 400c formed on the light input part between the guide parts 400b.

The mold frame 200 receives and fixes the light guide plate 400, the LED unit 300, and the optical sheets 500 thereto, and, in the present exemplary embodiment, is in the form of a tetragon. The mold frame 200 includes a sidewall 200a, a flat part 200b bent in a direction crossing the sidewall 200a, a recess part 200c formed on the flat part 200b on which the LED 300a is positioned, and a projection part 200d formed on the recess part 200c. Alternative exemplary embodiments include configurations wherein the recess part 200c and the flat part 200b on which the recess part 200c is formed are omitted.

In the first and second exemplary embodiments of the present invention as described above, the mold frame 200 is provided with the projection part 200d, and the projection part 200d positions the light output part of the LED 300a, which is provided between the mold frame 200 and the light input part of the light guide plate 400, in close contact with the light input part of the light guide plate 400 by applying force to the LED. In one exemplary embodiment, the projection part 200d may be made of substantially the same material as the mold frame 200, or may be separately prepared using a material different from the mold frame 200 and subsequently attached to the mold frame 200. Exemplary embodiments of the projection part 200d may be made of the same resin as the mold frame 200, rubber, or sponge. Also, in the exemplary embodiment wherein the projection part 200d is made of resin, it may be in the form of a plate spring having elasticity.

On the other hand, the receiving member 800 is configured to receive and protect the LCD panel 600 and the backlight unit 1000, and includes an upper receiving member provided on the upper part of the LCD panel 600 and a lower receiving member 100 provided on the lower part of the backlight unit 1000.

As described above, according to the LCD of the present invention, since the light output part of the LED 300a is in close contact with the light input part of the light guide plate 400, the light emitting efficiency of the backlight unit is increased, and thus the luminance of the LCD 600, which receives light from the backlight unit 1000, is improved in comparison to the conventional liquid crystal display.

According to the backlight unit and the LCD having the same according to the present invention, the mold frame is provided with the projection part formed thereon to position the light output part of the LED in close contact with the light input part of the light guide plate, and thus the light efficiency is maximized.

Also, the mold frame is provided with the projection part having elasticity to position the light output part of the LED in close contact with the light input part of the light guide plate, irrespective of the size error of the LED, and thus the light efficiency is maximized.

Also, the light emitting efficiency of the backlight unit is increased, and thus the display quality of the LCD is improved.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A backlight unit comprising:
a light emitting diode including a light output part;
a light guide plate having a light input part positioned substantially opposite to the light output part of the light emitting diode;
a mold frame configured to receive and fix the light emitting diode and the light guide plate therein; and
a projection part disposed on the mold frame in a position corresponding to the light emitting diode and the light input part of the light guide plate,
wherein a distance between the projection part and the light input part of the light guide plate is shorter than a distance between one side of the light output part of the light emitting diode and a rear surface of the other side of the light emitting diode.

2. The backlight unit of claim 1, wherein the mold frame comprises a sidewall configured to fix the light guide plate thereto, and the projection part is disposed on the sidewall.

3. The backlight unit of claim 1, wherein the mold frame comprises a flat part extending from the sidewall of the mold frame to an inner side thereof, and wherein the projection part is disposed on the flat part.

4. The backlight unit of claim 3, wherein the mold frame comprises a recess part disposed on the flat part of the mold frame, the recess part being configured to receive the light emitting diode therein, and
wherein the projection part is disposed on the recess part.

5. The backlight unit of claim 4, wherein the light guide plate comprises:
a flat base plate;
a plurality of guide parts projected from a side of the base plate; and
a light input part disposed between adjacent guide parts of the plurality of guide parts.

6. The backlight unit of claim 5, wherein the light guide plate is supported by the flat part of the mold frame.

7. The backlight unit of claim 1, wherein the projection part has a rounded edge in a direction corresponding to a direction from which the light emitting diode is mounted.

8. The backlight unit of claim 1, wherein the projection part contacts the rear surface of the light emitting diode.

9. The backlight unit of claim 8, wherein the light emitting diode comprises a concave part and convex parts disposed on the rear surface thereof.
wherein the convex parts are disposed on substantially opposite sides of the rear surface of the light emitting diode, and the concave part is disposed between the convex parts.

10. The backlight unit of claim 9, wherein a width of the concave part on the rear surface of the light emitting diode corresponds to a width of the projection part.

11. The backlight unit of claim 9, wherein a width of the projection is the same as or larger than a width of the rear surface of the light emitting diode.

12. The backlight unit of claim 1, wherein the projection part comprises an elastic member.

13. The backlight unit of claim 12, wherein the elastic member comprises at least one of a plate spring, rubber and sponge.

14. The backlight unit of claim 13, wherein the plate spring extends from the mold frame to a rear surface of the light emitting diode, and is bent in one of an upward and downward direction.

15. The backlight unit of claim 1, wherein the projection part and the mold frame comprise a single, indivisible unitary body.

16. The backlight unit of claim 1, wherein the projection part is separately prepared and attached to the mold frame.

17. A liquid crystal display comprising:
a liquid crystal display panel; and
a backlight unit configured to supply light to the liquid crystal display panel, and comprising:
a light emitting diode including a light output part;
a light guide plate having a light input part positioned substantially opposite to the light output part of the light emitting diode;
a mold frame configured to receive and fix the light emitting diode and the light guide plate therein; and
a projection part disposed on the mold frame in a position corresponding to the light emitting diode and the light input part of the light guide plate,
wherein a distance between the projection part and the light input part of the light guide plate is shorter than a distance between one side of the light output part of the light emitting diode and a rear surface of the other side of the light emitting diode.

18. The liquid crystal display of claim 17, wherein the projection part is in contact with a rear surface of the light emitting diode.

19. The liquid crystal display of claim 18, wherein the light emitting diode comprises a concave part and convex parts disposed on the rear surface thereof;
wherein the convex parts are disposed on opposing sides of the rear surface of the light emitting diode, and the concave part is disposed between the convex parts.

20. The liquid crystal display of claim 19, wherein a width of the concave part on the rear surface of the light emitting diode corresponds to a width of the projection part.

21. The liquid crystal display of claim 20, wherein a width of the projection is the same as or larger than a width of the rear surface of the light emitting diode.
